(19) United States
(12) Patent Application Publication
(10) Pub. No.: US 2015/0195461 A1
(43) Pub. Date: Jul. 9, 2015

(54) APPARATUS AND METHOD FOR IMAGE CORRECTION

(71) Applicant: SAMSUNG ELECTRO-MECHANICS CO., LTD., Suwon-Si (KR)

(72) Inventors: Myung Gu KANG, Suwon-Si (KR); Hee Yong YOO, Suwon-Si (KR); Sang Jin KIM, Suwon-Si (KR)

(21) Appl. No.: 14/589,720

(22) Filed: Jan. 5, 2015

Related U.S. Application Data
(63) Continuation-in-part of application No. 14/218,358, filed on Mar. 18, 2014.

(30) Foreign Application Priority Data
Jan. 3, 2014 (KR) 10-2014-0000753
Dec. 16, 2014 (KR) 10-2014-0181521

(51) Int. Cl. H04N 5/232; H04N 5/369; G02B 27/64

(52) U.S. Cl. CPC H04N 5/23287; G02B 27/646; H04N 5/369; H04N 5/23258

(57) ABSTRACT

An apparatus for image correction may include a first sensor configured to sense a movement of a camera module, a lens control unit configured to adjust a position of a lens in the camera module in accordance with the movement of the camera module sensed by the first sensor, a second sensor configured to sense the position of the lens adjusted in accordance with the movement, a movement point spread function calculation unit configured to calculate a movement point spread function based on a difference between the movement of the camera module sensed by the first sensor and the position of the lens sensed by the second sensor, and a correction unit configured to correct an image from the camera module based on the movement point spread function.

### CROSS-REFERENCE TO RELATED APPLICATIONS

This application claims priority to, and the benefit of, Korean Patent Application Nos. 10-2014-0000753 filed on Jan. 3, 2014 and 10-2014-0181521 filed on Dec. 16, 2014, with the Korean Intellectual Property Office, the disclosures of which are incorporated herein by reference.

### BACKGROUND

The present disclosure relates to an apparatus and a method for image correction.

Recently, as camera modules have been reduced in size in digital imaging apparatuses, such as digital cameras or smart phones, camera shake has become an issue. Camera shake refers to motion blur appearing in an image captured by a camera module due to motion of the camera module such as movement and rotation during exposure.

To overcome this, existing digital imaging apparatuses employ optical image stabilization (OIS) technology that corrects shake by adjusting the position of a lens by an amount corresponding to the amount of shake, or digital image stabilization (DIS), that performs post-correction on a captured image using a motion point spread function.

In the OSI scheme, however, an error between the amount of shake measured by a gyro sensor and the actual movement amount of a lens may occur, such that a degree of motion blur corresponding to the magnitude of the error remains.

Further, as for the DIS scheme, although the low manufacturing costs associated therewith are advantageous, it has poor performance in terms of removing motion blur, as compared to the OIS scheme.

### SUMMARY

An exemplary embodiment in the present disclosure may provide an apparatus and a method for image correction in which a movement point spread function is calculated based on movement of a camera sensed by a first sensor and a position of a lens sensed by a second sensor, and an image is corrected based thereon, so that a clearer image may be obtained.

According to an exemplary embodiment in the present disclosure, an apparatus for image correction may include: a first sensor configured to sense a movement of a camera module; a lens control unit configured to adjust a position of a lens in the camera module in accordance with the movement of the camera module sensed by the first sensor; a second sensor configured to sense the position of the lens adjusted in accordance with the movement; a movement point spread function calculation unit configured to calculate a movement point spread function based on a difference between the movement of the camera module sensed by the first sensor and the position of the lens sensed by the second sensor; and a correction unit configured to correct an image from the camera module based on the movement point spread function.

The lens control unit may be turned on or off by an external signal, and in the case in which the lens control unit is turned off, the movement point spread function calculation unit may calculate a movement point spread function based on the movement of the camera module sensed by the first sensor.

According to an exemplary embodiment in the present disclosure, an apparatus for image correction may include: a motion sensor configured to sense a movement of a camera module so as to generate a movement value; a lens control unit configured to calculate a motion vector corresponding to the movement based on the movement value and adjusting a position of a lens of the camera module based on the motion vector; a hall sensor configured to sense the position of the lens so as to generate a position value; a movement point spread function calculation unit configured to compare the movement value with a position value of the lens adjusted in accordance with the movement so as to calculate a movement point spread function; and a correction unit configured to correct an image captured by the lens based on the movement point spread function, wherein the lens control unit and the movement point spread function calculation unit are only operated while a shutter of the camera module is open.

According to an exemplary embodiment in the present disclosure, a method for image correction may include: a) sensing a movement of a camera module so as to generate a movement value; b) adjusting a position of a lens in the camera module in accordance with the movement value of the camera module; c) sensing the position of the lens so as to generate a position value of the lens; d) calculating a movement point spread function based on a difference between the movement value and the position value of the lens adjusted in accordance with the movement; and e) correcting an image from the camera module based on the movement point spread function.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram of an apparatus for image correction according to an exemplary embodiment in the present disclosure;

FIG. 2 is a block diagram of the lens control unit illustrated in FIG. 1 according to an exemplary embodiment in the present disclosure;

FIG. 3 is block diagram of the lens control unit illustrated in FIG. 1 according to another exemplary embodiment in the present disclosure;

FIG. 4 is a block diagram of an apparatus for image correction according to another exemplary embodiment in the present disclosure;

FIG. 5 is a graph illustrating a movement value and a position value when a movement of a camera module is within a correction angle limit;

FIG. 6 is a graph illustrating a motion value and a position value when the movement of the camera module is out of the correction angle limit;

FIG. 7 is a flowchart illustrating a method for image correction according to an exemplary embodiment in the present disclosure;

FIG. 8 is a flowchart illustrating adjusting of the position of a lens of the method illustrated in FIG. 7 according to an exemplary embodiment in the present disclosure; and

FIG. 9 is a flowchart illustrating a method for image correction according to another exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

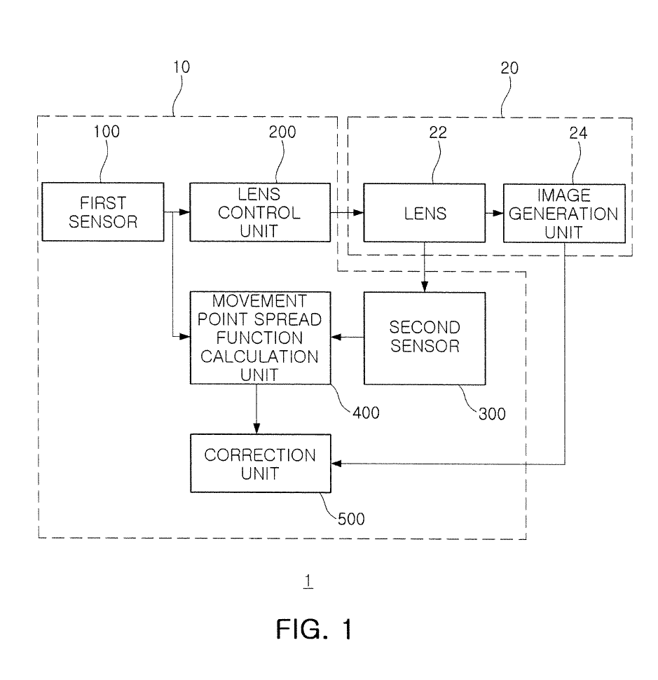

FIG. 1 is a block diagram of an apparatus for image correction according to an exemplary embodiment in the present disclosure.

Referring to FIG. 1, the apparatus 10 for image correction according to an exemplary embodiment in the present disclosure may include a first sensor 100, a lens control unit 200, a second sensor 300, a movement point spread function calculation unit 400, and a correction unit 500.

The apparatus 10 for image correction may be installed in a digital imaging device 1 (such as a digital camera or a smartphone) along with a camera module and may serve to correct an image captured by the camera module 20. The camera module 20 may include a lens 22 through which light passes and an image generation unit 24 that receives the light so as to generate an image signal.

Specifically, the apparatus 10 for image correction may sense shaking of the camera module 20 and may move the lens 22 in the camera module 20 in response to the shaking so as to prevent motion blur caused by the shaking. Further, the apparatus 10 for image correction may compare a sensed amount of shaking with the position of the lens 22, to calculate a movement point spread function and may correct the image captured by the camera module 20 based on the movement point spread function.

The first sensor 100 may sense the movement of the camera module 20. In an exemplary embodiment, the first sensor 100 may be a motion sensor sensing the movement, wherein the motion sensor may include at least one of a gyro sensor and an acceleration sensor.

In an exemplary embodiment, the first sensor 100 may be a gyro sensor that measures angular velocity of the camera module 20. The value of the angular velocity may include a pitch value or a yaw value. That is, the first sensor 100 may measure a pitch value and a yaw value of the camera module 20 and may output the measured values to the lens control unit 200.

The lens control unit 200 may adjust the position of the lens 22 in accordance with the movement of the camera module 20 sensed by the first sensor 100. In an exemplary embodiment, the lens control unit 200 may adjust the position of the lens 22 in a direction opposite to that of the movement of the camera module 20.

Specifically, the lens control unit 200 may calculate a motion vector corresponding to angular velocity of the camera module 20 sensed by the first sensor 100 and may adjust the position of the lens 22 in accordance with the calculated motion vector. The motion vector may be calculated by integrating values of the angular velocity. The lens control unit 200 may only be operated while a shutter (not shown) of the camera module 20 is open.

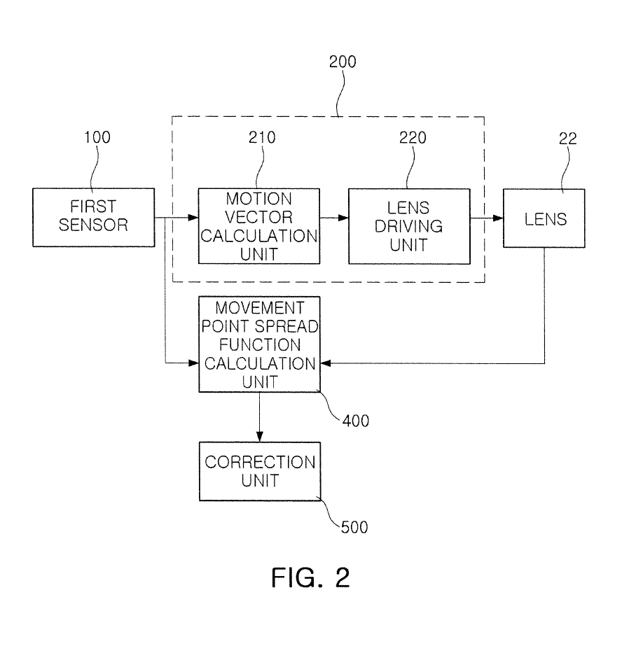

The configuration of the lens control unit 200 will be described in detail with respect to FIG. 2.

The second sensor 300 may sense the position of the lens 22 of the camera module 20. In an exemplary embodiment, the second sensor 300 may be a hall sensor. The second sensor 300 may sense and output the position of the lens 22 to the movement point spread function calculation unit 400.

The movement point spread function calculation unit 400 may calculate a movement point spread function based on a difference between the movement value of the camera module 20 sensed by the first sensor 100 and the position value of the lens 22 sensed by the second sensor 300 and adjusted in accordance with the movement value. In an exemplary embodiment, the movement point spread function calculation unit 400 may compare the pitch values and yaw values sensed by the first sensor 100 with an x-coordinate value and a y-coordinate value sensed by the second sensor 300 so as to calculate the movement point spread function. In an exemplary embodiment, the movement point spread function calculation unit 400 may only be operated while a shutter (not shown) of the camera module 20 is open.

The correction unit 500 may correct an image generated by the image generation unit 24 in the camera module 20 based on the movement point spread function calculated by the movement point spread function calculation unit 400.

In an exemplary embodiment, the correction unit 500 may perform deconvolution on the movement point spread function and an image generated by the image generation unit 24 using an image restoration filter, so as to correct image blur.

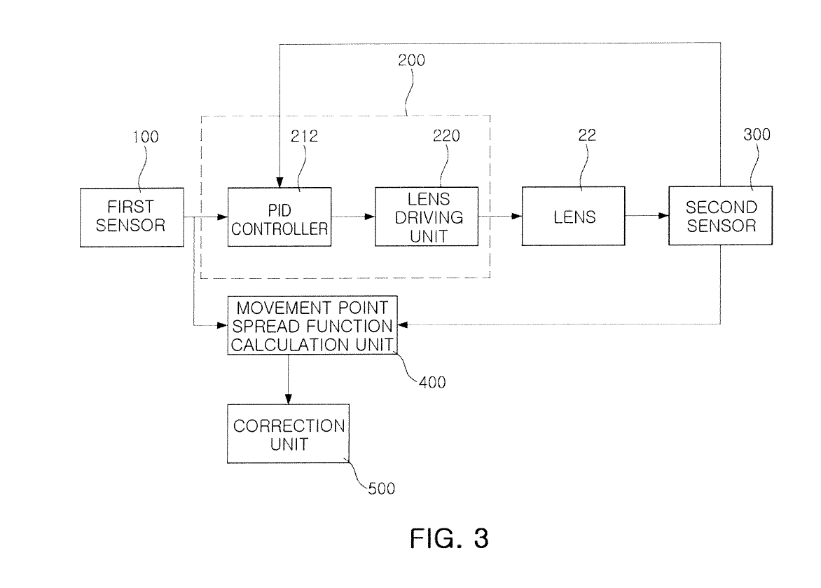

FIG. 2 is a block diagram of the lens control unit illustrated in FIG. 1 according to an exemplary embodiment in the present disclosure, and FIG. 3 is block diagram of the lens control unit illustrated in FIG. 1 according to another exemplary embodiment in the present disclosure.

Referring to FIG. 2, the lens control unit 200 according to an exemplary embodiment in the present disclosure may include a motion vector calculation unit 210 and a lens driving unit 220.

The motion vector calculation unit 210 may calculate a motion vector of the lens 22 in accordance with the movement of the camera module 20 sensed by the first sensor 100. That is, in order to prevent motion blur occurring due to the shaking of the camera module 20, the motion vector calculation unit 210 may generate a motion vector that includes values corresponding to the amount of movement in the direction that the movement of the camera module 20 is compensated.

In an exemplary embodiment, the motion vector calculation unit 210 may receive a feedback signal indicating the position of the lens 22 from the second sensor 300 so as to calculate a motion vector, as illustrated in FIG. 3 and may be a PID controller.

The lens driving unit 220 may adjust the position of the lens 22 based on the motion vector calculated by the motion vector calculation unit 210. The lens driving unit 220 may adjust the position of the lens 22 in a PWM manner or in a linear manner.

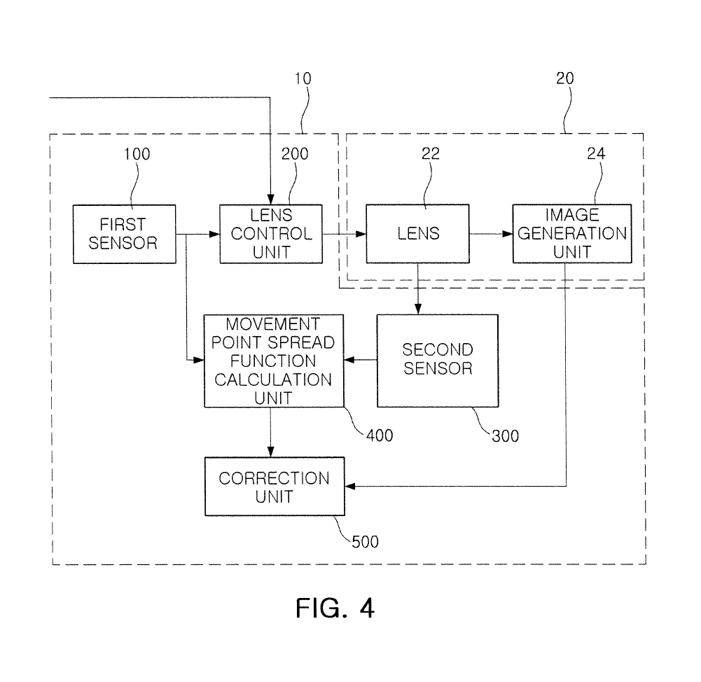

FIG. 4 is a block diagram of an apparatus for image correction according to another exemplary embodiment in the present disclosure.

Basic configurations illustrated in FIG. 4 according to an exemplary embodiment in the present disclosure are the same as those illustrated in FIGS. 1 through 3 according to exemplary embodiments of the present disclosure. However, the lens control unit 200 may be turned on or off by an external signal and the operation in which the movement point spread function calculation unit 400 calculates the movement point spread function may be different, depending on the turning on or off of the lens control unit 200.

Specifically, the lens control unit 200 may be turned on or off by the external signal. Here, the external signal may be a user input for turning on or off a function that prevents the motion blur by adjusting the position of the lens 22 in accordance with the shaking of the camera module 20 and the lens control unit 200 may be turned on or off depending on the external signal.

In the case in which the lens control unit 200 is turned on, the movement point spread function calculation unit 400 may calculate the movement point spread function based on a difference between a movement value sensed by the first sensor 100 and a position value of the lens 22 sensed by the second sensor.

Here, in the case in which the lens control unit 200 is turned off, the movement point spread function calculation unit 400 may calculate the movement point spread function based on the movement value sensed by the first sensor 100.

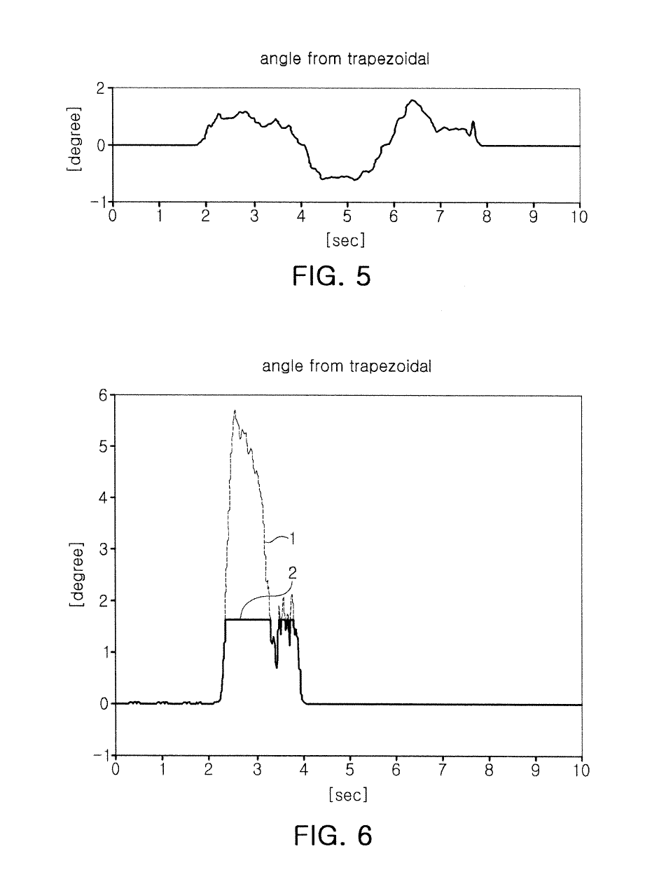

FIG. 5 is a graph illustrating a movement value and a position value when a movement of a camera module is within a correction angle limit and FIG. 6 is a graph illustrating a motion value and a position value when the movement of the camera module is out of the correction angle limit.

Referring to FIG. 5, when the movement of the camera module is within the correction angle limit (e.g., about ±1.6°), since a movement value sensed by the first sensor 100 and a position value of the lens adjusted in accordance with the movement value are approximately the same, they may be illustrated by a solid line. Here, the correction angle limit may refer to a maximum value of the position of the lens 22 that may be adjusted by the lens control unit 200.

Referring to FIG. 6, a case in which the movement of the camera module is out of the correction angle limit (e.g., about ±1.6°) may occur. In this section, an error may occur between the movement value 1 and the position value 2 of the lens 22 that is adjusted in accordance with the movement value. In this case, in spite of the position adjustment of the lens 22 by the lens control unit 200, motion blur may occur.

In an exemplary embodiment, in order to solve the above-mentioned problem, the lens control unit 200 may reduce a scale of the movement value in the above-mentioned section within the correction angle limit and adjust the position of the lens 22 based on the reduced movement value. However, since there is a difference between the reduced movement value and an actual movement value, the motion blur may remain even though the position of the lens 22 is adjusted based on the reduced movement value.

In order to solve the above-mentioned problem, the apparatus for image correction may include the lens control unit 200 that adjusts the position of the lens 22 based on the movement value itself sensed by the first sensor 100 regardless of whether or not the movement of the camera module is out of the correction angle limit, the movement point spread function calculation unit 400 that calculates the movement point spread function based on the difference between the movement value and the position value of the lens 22 that is adjusted in accordance with the movement, and the correction unit 500 that corrects an image based on the movement point spread function, so as to clearly correct image blur due to a movement of the camera module even though the movement of the camera module is out of a correction angle limit range.

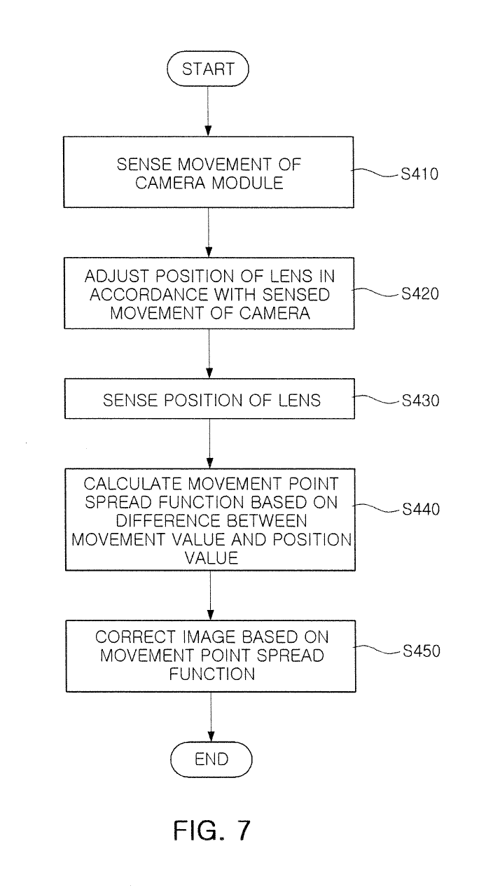

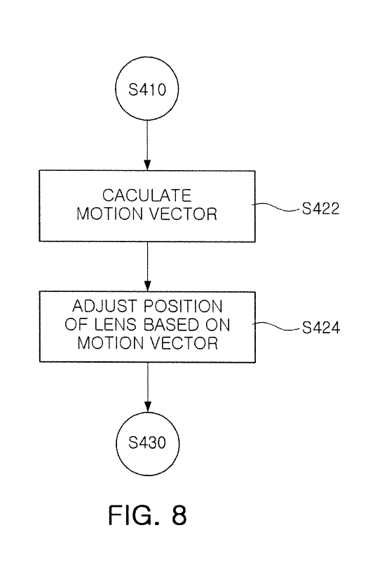

FIG. 7 is a flowchart illustrating a method for image correction according to an exemplary embodiment in the present disclosure and FIG. 8 is a flowchart illustrating adjusting of the position of a lens of the method illustrated in FIG. 7 according to an exemplary embodiment in the present disclosure.

The method for image correction illustrated in FIG. 7 according to an exemplary embodiment is performed by the apparatus 10 for image correction described above with reference to FIGS. 1 through 3, and thus redundant descriptions will not be made.

Referring to FIG. 7, the apparatus 10 for image correction may sense movement of the camera module 20 (S410) Then, the apparatus 10 for image correction may adjust the position of the lens 22 in accordance with the sensed movement of the camera module 20 (S420). In an exemplary embodiment, in the adjusting of the position of the lens 22 (S420), the position of the lens 22 may be adjusted in a direction that the movement of the camera module 20 is compensated.

Then, the apparatus 10 for image correction may sense the position of the lens 22 (S430) and may calculate a movement point spread function based on a difference between the sensed movement value of the camera module 20 and the position value of the lens 22 (S440).

Then, the apparatus 10 for image correction may correct an image captured by the camera module 20 based on the calculated movement point spread function (S450).

In an exemplary embodiment, as illustrated in FIG. 8, the adjusting of the position of the lens (S420) may include calculating a motion vector of the lens 22 corresponding to the sensed movement of the camera module 20 (S422), and adjusting the position of the lens 22 according to the calculated motion vector of the lens 22 (S424).

In an exemplary embodiment, operations S410 to S440 may be performed only while a shutter of the camera module 20 is open and may be repeatedly performed a predetermined number of times depending on the time period in which the shutter of the camera module 20 is open.

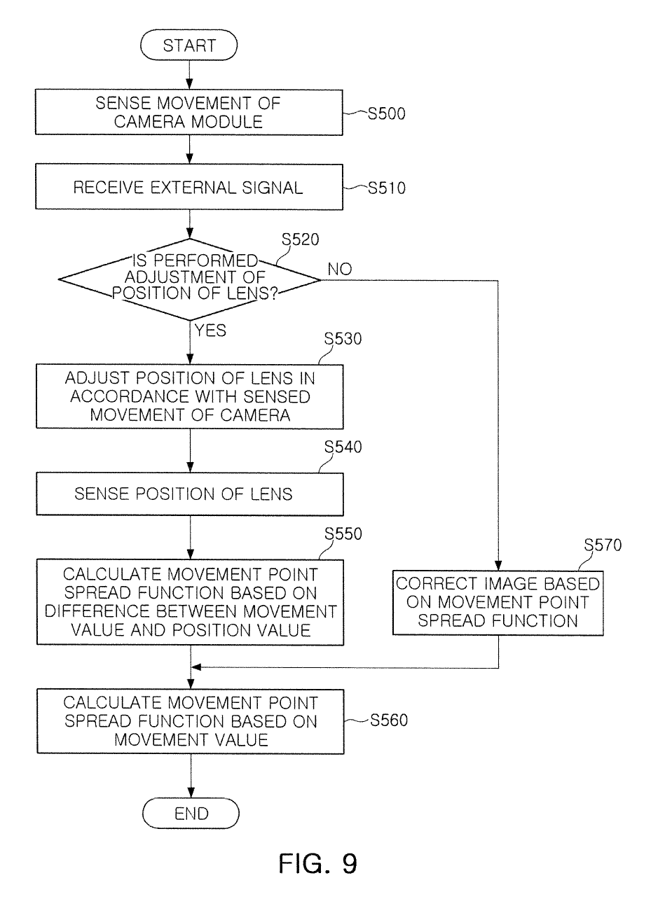

FIG. 9 is a flowchart illustrating a method for image correction according to another exemplary embodiment in the present disclosure.

The method for image correction illustrated in FIG. 9 according to another exemplary embodiment is performed by the apparatus 10 for image correction described above with reference to FIG. 4, and thus redundant descriptions will not be made.

Referring to FIG. 9, the apparatus 10 for image correction may sense movement of the camera module 20 so as to generate a movement value (S500). Then, the apparatus 10 for image correction may receive an external signal about whether or not it performs the adjusting of the position of the lens from outside (S510). Here, since the adjusting of the position of the lens may be performed by the lens control unit 200, the external signal may be a signal that determines turning on or off of the lens control unit 200. Here, the receiving of the external signal (S510) may be performed prior to the generating of the movement value (S500).

Then, in the case in which the external signal is a signal that allows the position adjustment of the lens to be performed, that is, a signal that turns on the lens control unit 200 (S520), the apparatus 10 for image correction may adjust the position of the lens in accordance with the movement of the camera module 20 (S530). Then, the apparatus 10 for image correction may sense the adjusted position of the lens to generate a position value (S540).

Then, the apparatus 10 for image correction may calculate a movement point spread function based on a difference between the generated movement value and the generated position value (S550).

Then, the apparatus 10 for image correction may correct an image based on the calculated movement point spread function (S560).

Here, in the case in which the external signal is a signal that does not allow the position adjustment of the lens to be performed, that is, a signal that turns off the lens control unit 200 (S520), the apparatus 10 for image correction may calculate the movement point spread function based on the movement value (S570) and may correct the image based on the calculated movement point spread function (S540).

In an exemplary embodiment, as illustrated in FIG. 8, the adjusting of the position of the lens (S530) may include calculating a motion vector of the lens 22 corresponding to the sensed movement of the camera module 20 (S422), and adjusting the position of the lens 22 according to the calculated motion vector of the lens 22 (S424).

In an exemplary embodiment, operations S510 to S530 or S540 may be performed only while a shutter of the camera module 20 is open and may be repeatedly performed a predetermined number of times depending on the time period in which the shutter of the camera module 20 is open.

As set forth above, according to exemplary embodiments of the present disclosure, a movement point spread function is calculated based on a movement of a camera module sensed by a first sensor and a position of a lens sensed by a second sensor, and an image is corrected based thereon, so that a clearer image may be obtained.

While exemplary embodiments have been shown and described above, it will be apparent to those skilled in the art that modifications and variations could be made without departing from the scope of the present invention as defined by the appended claims.

What is claimed is:

1. An apparatus for image correction, comprising:
a first sensor configured to sense a movement of a camera module;
a lens control unit configured to adjust a position of a lens in the camera module in accordance with the movement of the camera module sensed by the first sensor;
a second sensor configured to sense the position of the lens adjusted in accordance with the movement;
a movement point spread function calculation unit configured to calculate a movement point spread function based on a difference between the movement of the camera module sensed by the first sensor and the position of the lens sensed by the second sensor; and
a correction unit configured to correct an image from the camera module based on the movement point spread function.

2. The apparatus of claim 1, wherein the lens control unit adjusts the position of the lens in a direction that the movement of the camera module sensed by the first sensor is compensated.

3. The apparatus of claim 1, wherein the first sensor senses angular velocity of the camera module, and the lens control unit calculates a motion vector of the lens corresponding to the angular velocity of the camera module sensed by the first sensor and adjusts the position of the lens according to the calculated motion vector of the lens.

4. The apparatus of claim 3, wherein the movement point spread function calculation unit calculates the movement point spread function based on a difference between a value of angular velocity sensed by the first sensor and a value of a position of the lens sensed by the second sensor.

5. The apparatus of claim 3, wherein the motion vector is calculated by integrating values of angular velocity sensed by the first sensor.

6. The apparatus of claim 1, wherein the lens control unit includes:
a motion vector calculation unit configured to calculate a motion vector of the lens corresponding to the movement of the camera module sensed by the first sensor; and
a lens driving unit configured to adjust the position of the lens based on the calculated motion vector of the lens.

7. The apparatus of claim 6, wherein the motion vector calculation unit receives a feedback signal indicating the position of the lens from the second sensor to calculate the motion vector.

8. The apparatus of claim 1, wherein the movement point spread function calculation unit is only operated while a shutter of the camera module is open.

9. The apparatus of claim 1, wherein the first sensor is a gyro sensor configured to detect angular velocity of the camera module.

10. The apparatus of claim 1, wherein the second sensor is a hall sensor configured to detect the position of the lens.

11. The apparatus of claim 1, wherein the lens control unit is turned on or off by an external signal, and
in the case in which the lens control unit is turned off, the movement point spread function calculation unit calculates a movement point spread function based on the movement of the camera module sensed by the first sensor.

12. The apparatus of claim 11, wherein the first sensor senses angular velocity of the camera module to generate a value of angular velocity, and
the movement point spread function calculation unit calculates a movement point spread function based on the value of angular velocity sensed by the first sensor.

13. An apparatus for image correction, comprising:
a motion sensor configured to sense a movement of a camera module so as to generate a movement value;
a lens control unit configured to calculate a motion vector corresponding to the movement based on the movement value and adjusting a position of a lens in the camera module based on the motion vector;
a hall sensor configured to sense the position of the lens so as to generate a position value;
a movement point spread function calculation unit configured to compare the movement value with a position value of the lens adjusted in accordance with the movement so as to calculate a movement point spread function; and
a correction unit configured to correct an image captured by the lens based on the movement point spread function,
wherein the lens control unit and the movement point spread function calculation unit are only operated while a shutter of the camera module is open.

14. The apparatus of claim 13, wherein the lens control unit calculates a motion vector of the lens corresponding to the movement value of the camera module sensed by the motion sensor and adjusts the position of the lens based on the calculated motion vector of the lens.

15. The apparatus of claim 14, wherein the motion sensor includes a gyro sensor that senses angular velocity of the camera module so as to generate a value of angular velocity, and
the lens control unit calculates the motion vector by integrating values of angular velocity sensed by the gyro sensor.

16. The apparatus of claim 13, wherein the lens control unit includes:
a motion vector calculation unit configured to calculate a motion vector of the lens corresponding to the movement value of the camera module sensed by the motion sensor; and
a lens driving unit configured to adjust the position of the lens based on the calculated motion vector of the lens.

17. The apparatus of claim 16, wherein the motion vector calculation unit receives a feedback signal indicating the position of the lens from the hall sensor to calculate the motion vector.

18. The apparatus of claim 13, wherein the lens control unit is turned on or off by an external signal, and
in the case in which the lens control unit is turned off, the movement point spread function calculation unit calculates a movement point spread function based on the movement value.

19. A method for image correction, comprising:
a) sensing a movement of a camera module so as to generate a movement value;
b) adjusting a position of a lens in the camera module in accordance with the movement value of the camera module;
c) sensing the position of the lens so as to generate a position value of the lens;
d) calculating a movement point spread function based on a difference between the movement value and the position value of the lens adjusted in accordance with the movement; and
e) correcting an image from the camera module based on the movement point spread function.

20. The method of claim 19, wherein operation a) of adjusting of the position of the lens includes calculating a motion vector of the lens corresponding to the sensed movement of the camera module; and adjusting the position of the lens based on the calculated motion vector of the lens.

21. The method of claim 19, wherein operations a) to d) are repeatedly performed a predetermined number of times depending on the time period in which a shutter of the camera module is open.

22. The method of claim 19, further comprising, after operation a) of sensing of the movement of the camera module,
determining whether or not operation b) is performed by an external signal;
in the case in which operation b) is not performed, calculating the movement point spread function based on the sensed movement of the camera module; and
correcting an image from the camera module based on the movement point spread function.
